(19) United States
(12) Patent Application Publication
(10) Pub. No.: US 2013/0028600 A1
(43) Pub. Date: Jan. 31, 2013

(54) Configurable Multi-Format Transceiver System

(71) Applicants: Jae Joon Chang, Johns Creek, GA (US); Youngsik Hur, Alpharetta, GA (US)

(72) Inventors: Jae Joon Chang, Johns Creek, GA (US); Youngsik Hur, Alpharetta, GA (US)

(73) Assignee: SAMSUNG ELECTRO-MECHANICS COMPANY, LTD., Gyunggi-Do (KR)

(21) Appl. No.: 13/560,400

(22) Filed: Jul. 27, 2012

Related U.S. Application Data
(60) Provisional application No. 61/512,903, filed on Jul. 28, 2011.

(51) Int. Cl. H04B 1/44; H04B 10/24

(52) U.S. Cl. 398/41; 370/278

(57) ABSTRACT

A communication system includes a configurable transceiver that accommodates multi-band, multi-format signals by incorporating a duplex transceiver circuit, a simplex transceiver circuit and at least two switches. A first switch may be operated so as to configure the configurable transceiver to propagate duplex signals, such as for example, frequency division multiplexed (FDD) signals. The second switch may be operated so as to configure the simplex transceiver circuit to provide signal propagation of various types of signals in either a receive direction or a transmit direction. The various types of signals include time division multiplexed (TDD) signals.

### RELATED APPLICATION

The present application claims priority to U.S. Provisional Patent Application No. 61/512,903, filed Jul. 28, 2011, and entitled “HYBRID RoF STRUCTURE FOR MULTI-BAND OPERATION USING ONE OR MORE SWITHCES AND DUPLEXERS,” which is hereby incorporated in its entirety as if fully set forth herein.

### DESCRIPTION OF THE RELATED ART

Various types of signal transmission media are typically selected on the basis of a frequency bandwidth associated with a signal. For example, human voice generally occupies a frequency bandwidth on the low end of the frequency spectrum, and consequently, voice signals can be propagated through wires such as a twisted pair of wires as used in wire-line telephony. On the other hand, television signals occupy a frequency bandwidth that is significantly higher than that of voice signals. As a result, television signals are propagated through a cable medium rather than twisted pair wire media, because the cable medium can transport the television signal over a greater distance with less distortion and attenuation in comparison to twisted pair wire media. However, cable media cannot optimally support the transportation of higher frequency signals such as microwave frequency radio signals that are transmitted over the air. As can be appreciated, each type of transmission medium has an associated advantage as well as associated handicaps such as performance trade-offs and cost trade-offs.

Attention is drawn to FIGS. 1 and 2 to provide elaboration upon a few of these trade-offs. FIG. 1 shows two types of transmission media that are used to propagate to a residence 125, a few signals of various bandwidths. Twisted pair wire-line medium 110 that connects Central Office (CO) 105 to residence 125, is used to transport telephone voice signals in combination with digital computer data.

Splitter 115 routes the low frequency telephone voice signals to a telephone 120 and routes the computer data (carried in a digital subscriber line (DSL) frequency bandwidth that is located above human voice bandwidth) to a computer 130. Unfortunately, twisted pair wire-line medium 110 places delivery distance constraints upon the DSL frequency bandwidth, therefore limiting delivery of computer data to a certain radius around CO 105. As can be understood, it would be preferable to expand this radius in order to provide computer data service (e.g. Internet access) to more customers and earn more revenue based on such delivery.

Turning now to the other transmission medium shown in FIG. 1, television signals (located in a frequency bandwidth well above the DSL frequency bandwidth) are beamed through free-space from a satellite-mounted dish antenna 145 to a terrestrial satellite dish antenna 150, from where the signals are conveyed to a television set 135 inside residence 125.

The free-space transmission medium places certain limitations such as signal loss and/or signal quality degradation as a result of obstacles (rain clouds, trees, buildings etc.) in the propagation path. Naturally, it would be preferable to transport the television signals while minimizing or eliminating some of these handicaps.

FIG. 2 shows a microwave communications system wherein radio signals at microwave frequencies are propagated in a line-of-sight free-space configuration between microwave transmitter 205 and several microwave receivers, such as receivers 215 and 220. This configuration suffers from certain handicaps. For example, receiver dish antenna 230 is located too far away from transmitter dish antenna 225 thereby leading to signal loss in microwave receiver 215. On the other hand, receiver dish antenna 235 is located within signal receiving range. But, in this case, the presence of obstruction 210 blocks the microwave signals transmitted from transmitter dish antenna 225 towards receiver dish antenna 235.

The handicaps explained above have been mitigated to some extent by exploiting the wide bandwidth characteristics of optical fiber for transporting a variety of signals that are combined together using various schemes (modulation schemes, multiplexing schemes etc). This alternative approach does provide certain advantages. However, these advantages are obtained at a price—specifically a high price associated with hardware, software and/or operating costs.

To elaborate upon this aspect in some detail, as is known, the various signals that are to be combined together in order to take advantage of the wide bandwidth characteristics of optical fiber may be provided in a variety of different formats. For example, a first signal that is carried on the twisted pair wire-line medium 110 of FIG. 1 may be a time division multiplexed (TDM) signal, while the television signal propagated from satellite-mounted dish antenna 145 may be a frequency division multiplexed (FDM) signal. If it is desirable to take advantage of the wide bandwidth characteristics of optical fiber, these two signals have to be combined in some manner so as to inject the combined signal into the optical fiber. Typically, this scenario may be resolved by using two different sets of equipment that are coupled to the optical fiber. However, as can be appreciated using two different sets of equipment to accommodate the two different formats not only contributes to increased system and operational costs but also leads to various operational inflexibilities, inefficiencies and incompatibilities.

It is therefore desirable in view of the remarks above, that transmission media cost, equipment cost, and equipment complexity be minimized in communication systems catering to wideband, multi-format signals.

### SUMMARY

According to a first aspect of the disclosure, a configurable transceiver includes a duplex transceiver circuit, a simplex transceiver circuit, and two switches. The duplex transceiver circuit includes a first antenna operative over a first radio frequency band; a first transmitter configured to operate upon a first transmit signal having a first communication format; and a first receiver configured to operate upon a first receive signal having the first communication format. A first switch is operable to selectively couple the first antenna to the duplex circuit when the communication transceiver is configured to enable a duplex mode of operation, and to selectively decouple the first antenna from the duplex circuit when the communication transceiver is configured for disabling the duplex mode of operation. The simplex transceiver circuit includes a second antenna operative over a second radio frequency band; a second transmitter configured to operate upon a second transmit signal having a second communication format; and a second receiver configured to operate upon a second receive signal having the second communication format. A second switch is operable to selectively couple the second antenna to either the second transmitter, when the communication transceiver is configured to enable a transmit mode of operation in the second communication format, or the second receiver when the communication transceiver is selectively configured to enable a receive mode of operation in the second communication format.

According to a second aspect of the disclosure, a method of operating a configurable transceiver, includes enabling a duplex mode of operation by activating a first switch to couple a first antenna to a duplex transceiver circuit, wherein the duplex transceiver circuit includes a first transmitter configured to operate upon a first transmit signal having a first communication format; and a first receiver configured to operate upon a first receive signal having the first communication format. The method further includes enabling a first simplex mode of operation by activating a second switch to couple a second antenna into one of a) a second transmitter that is configured to operate upon a second transmit signal having a second communication format or b) a second receiver that is configured to operate upon a second receive signal having the second communication format.

According to a third aspect of the disclosure, a configurable transceiver includes a duplex transceiver circuit, a simplex transceiver circuit, and two switches. The duplex transceiver circuit includes a first antenna operative over a first radio frequency band; a first transmitter configured to operate upon a first transmit signal occupying at least a portion of the first radio frequency band; and a first receiver configured to operate upon a first receive signal occupying the at least a portion of the first radio frequency band. A first switch is operable to selectively couple the first antenna to the duplex transceiver circuit when the communication transceiver is configured to enable a duplex mode of operation, and to selectively decouple the first antenna from the duplex transceiver circuit when the communication transceiver is configured for disabling the duplex mode of operation. The first simplex transceiver circuit includes a second antenna operative over a second radio frequency band; a second transmitter configured to operate upon a second transmit signal occupying at least a portion of the second radio frequency band; and a second receiver configured to operate upon a second receive signal occupying the at least a portion of the second radio frequency band. A second switch is operable to selectively couple the second antenna to either the second transmitter or the second receiver.

Further aspects of the disclosure are shown in the specification, drawings and claims below.

### BRIEF DESCRIPTION OF THE DRAWINGS

Many aspects of the invention can be better understood with reference to the following drawings. The components in the drawings are not necessarily to scale. Instead, emphasis is placed upon clearly illustrating the principles of the invention. Moreover, in the drawings, like reference numerals designate corresponding parts, or descriptively similar parts, throughout the several views and embodiments.

FIG. 1 shows a prior art communication system that includes a pair of transmission media for propagating signals of various bandwidths.

FIG. 2 shows a prior art microwave communications system in which microwave frequency signals are propagated in a line-of-sight free-space configuration.

FIG. 3 shows an exemplary embodiment of a communication system incorporating two configurable transceivers in accordance with the invention.

FIG. 4 shows a configurable transceiver in accordance with the invention.

FIG. 5 shows some exemplary elements contained inside some circuits of configurable transceiver.

FIG. 6 shows an exemplary configuration implemented on configurable transceiver 400.

FIG. 7 shows a flowchart of a method of operating configurable transceiver.

### DETAILED DESCRIPTION

Throughout this description, embodiments and variations are described for the purpose of illustrating uses and implementations of the inventive concept. The illustrative description should be understood as presenting examples of the inventive concept, rather than as limiting the scope of the concept as disclosed herein. It will also be understood that the word “example” as used herein (in whatever context) is intended to be non-exclusionary and non-limiting in nature. Specifically, the word “exemplary” indicates one among several examples, and it must be understood that no special emphasis is intended or suggested for that particular example. A person of ordinary skill in the art will understand the principles described herein and recognize that these principles can be applied to a wide variety of applications using a wide variety of configurations and hardware elements.

The various embodiments described herein generally pertain to systems and methods related to a communication system that caters to multi-band, multi-format signals by using a configurable transceiver. The multi-band signals include many different signals, ranging from baseband frequencies to microwave frequencies and having a variety of formats. At this point, it may be pertinent to point out that terms such as “baseband,” “radio frequency (RF)” and “microwave” that are used herein are not necessarily defined by a rigid range of frequencies, but are instead flexibly definable in the context of various applications.

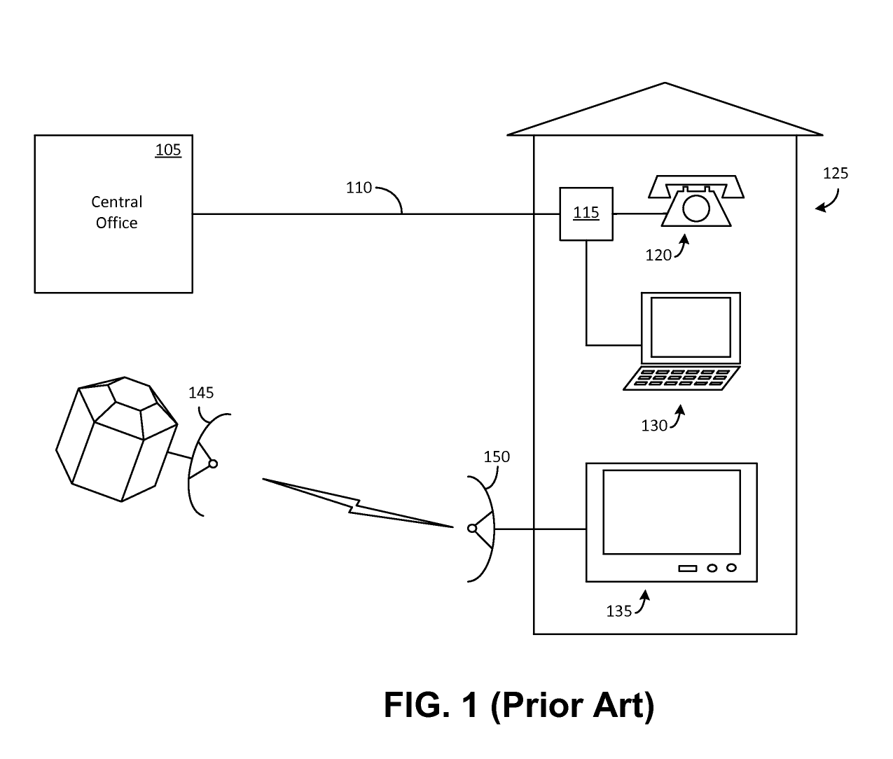

For example, when the various signals shown in FIG. 1 are combined in accordance with one exemplary embodiment of the invention, the voice frequency analog signals (telephone calls) may constitute the “baseband” signals, the DSL signals (computer data) may constitute the “RF” signals, and the high frequency signals (modulated satellite television signals) may constitute the “microwave” frequencies as referred to herein.

On the other hand, in another exemplary embodiment in accordance with the invention, analog or digital signals occupying a frequency spectrum below the very high frequency (VHF) band may constitute “baseband” frequencies, while signals in the VHF and ultra-high frequency (UHF) frequencies may constitute “RF” signals, and signals in the frequency spectrum above UHF frequencies (to whatever upper limit) may constitute the “microwave” frequencies, as referred to herein.

Furthermore, it should be notes that in accordance with a few embodiments described below, there are some references made to some standards such as, for example, 3G, 4G, WiMax, and LTE standards. As can be appreciated, communications-related standards evolve over time and are often modified. Nonetheless, it should be understood that changes to the various standards do not adversely affect the operability and the application of the various embodiments described herein. Furthermore, when such terms are used in the claims, the claims remain valid for all versions and evolutionary modifications of the various standards.

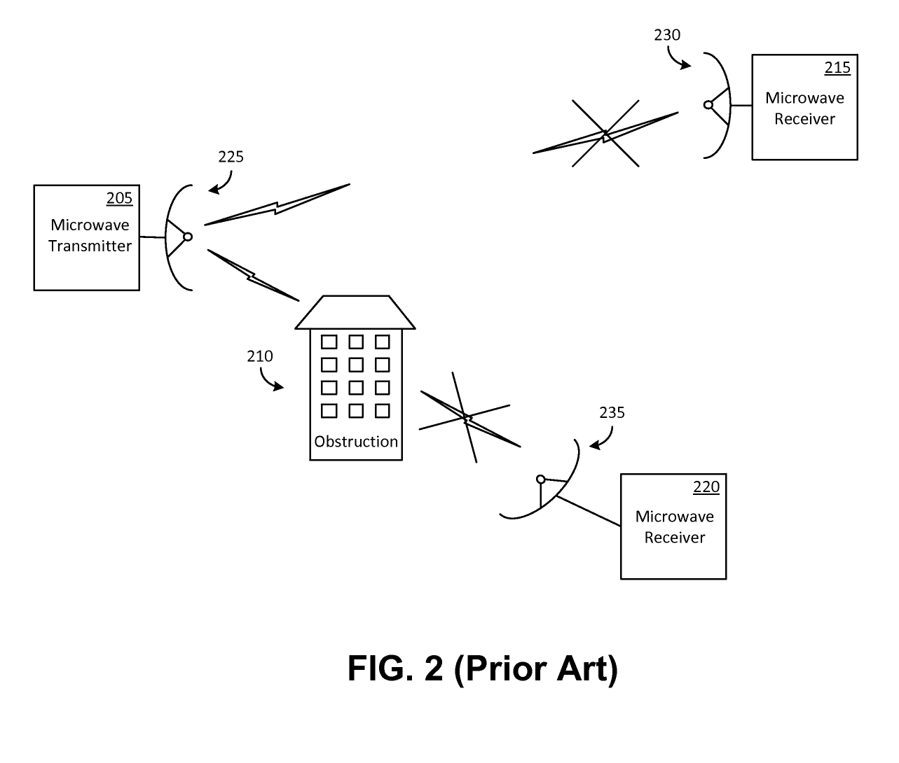

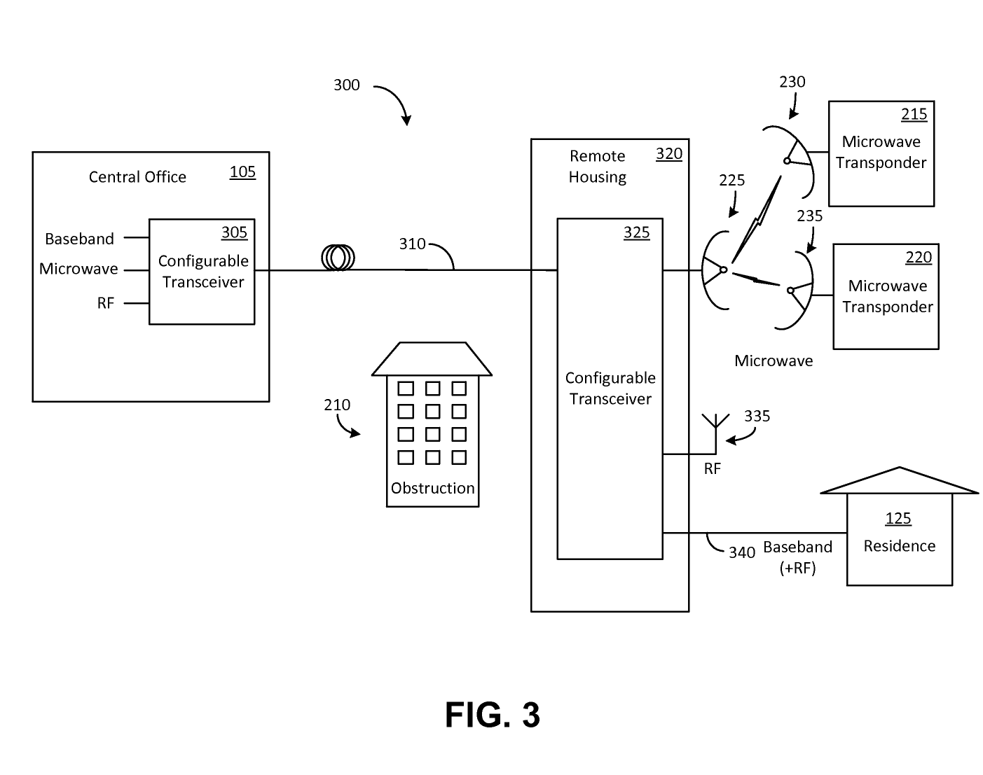

Attention is now drawn to FIG. 3, which shows an exemplary multi-band, multi-format communication system 300 in accordance with the invention. This exemplary configuration, which includes certain elements that are shown in FIGS. 1 and 2, is used to illustrate how communication system 300 may be used in place of some prior art systems. Furthermore, it will be understood that communication system 300 may be used in a wide variety of applications that bear little or no resemblance to the prior art systems shown in FIGS. 1 and 2.

Central Office (CO) 105 houses a configurable transceiver 305 that accepts one or more signals occupying multiple frequency bands and one or more similar or dissimilar communication formats. An output port of configurable transceiver 305 is coupled to an optical fiber 310, which may be a single-mode or a multi-mode optical fiber in accordance with a desired operational bandwidth. At the other end of optical fiber 310, the one or more signals are received in configurable transceiver 325, which may be similar to configurable transceiver 305 in some embodiments, and different in other embodiments. Configurable transceiver 325 located in a remote housing 320, receives the one or more signals transmitted via the optical fiber 310 and routes the received signals to output ports that are coupled to suitable signal transmission elements (microwave dish antenna, RF antenna, coaxial cable etc).

To elaborate upon this configuration, a baseband signal that is provided to configurable transceiver 305 may be combined with a radio frequency (RF) signal and/or a microwave signal that may also be provided to configurable transceiver 305, before the combined signal is injected into optical fiber 310. The manner in which this combining is carried out (which is described below in more detail) leads to an improvement in signal reach and system performance, and may also contribute to reduced system costs.

As explained above with reference to FIG. 1, DSL operational reach is limited due to transportation over twisted pair wires. The prior art operational reach is significantly improved by using optical fiber 310, which can not only carry the RF signals (e.g. DSL frequencies) but also carry the baseband (telephone) frequencies over significantly greater distances with reduced attenuation and distortion.

Configurable transceiver 325 recovers the base-band frequency portion of the combined signal and transmits this baseband portion to residence 125, via transmission medium 340. Transmission medium 340 may be twisted pair wiring having the same length as the twisted pair of wires shown in FIG. 1, thereby extending the signal delivery area of the base-band portion by a length corresponding to that of optical fiber 310. As can be understood, the introduction of optical fiber 310 thus extends the overall delivery distance from CO 105 to residence 125 by a significant amount. When the RF signals shown in FIG. 3 are DSL signals, these RF signals may be combined with the baseband portion and the combination provided to residence 125 via the twisted pair of wires indicated by transmission medium 340. Alternatively, the RF signals may be transmitted to the residence 125 or other destinations, by using an RF antenna 335.

The microwave signal portion provided to configurable transceiver 305 (and carried over optical fiber 310 along with the baseband and the RF frequency signals) is processed in configurable transceiver 325 before transmission out of microwave dish antenna 225 to receiver dish antennae 230 and 235. As can be seen the adverse effect of obstruction 210 between transmitter dish antenna 225 and receiver dish antenna 235 has now been eliminated.

Also, the distance handicap between transmitter dish antenna 225 and receiver dish antenna 230 has also been eliminated.

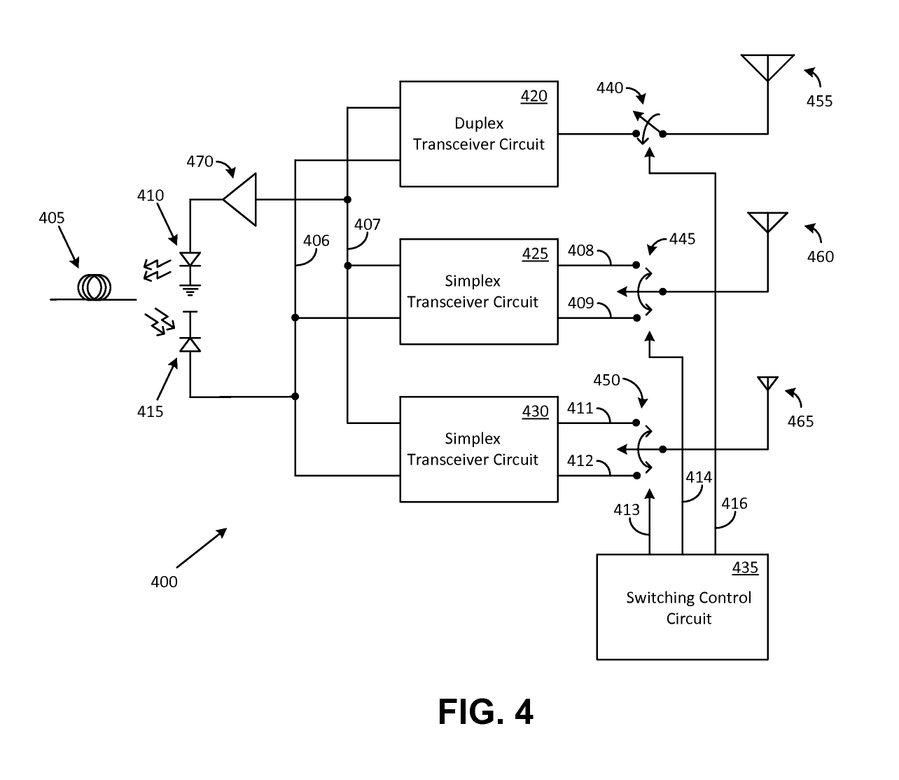

FIG. 4 shows a configurable transceiver 400 in accordance with the invention. Optical fiber 405 is optically coupled to configurable transceiver 400, specifically to an optical receiver device 415 (pictorially depicted by a photo-detector diode) and to an optical transmitter device 410 (pictorially depicted by a light-emitting diode) in configurable transceiver 400. Various types of devices may be used to implement optical receiver device 415 and optical transmitter device 410.

For example, in certain embodiments, optical fiber 405 is a multimode optical fiber, optical transmitter device 410 is a light emitting diode (LED), and optical receiver device 415 is a relatively low-speed device selected in accordance with the low-speed, small-bandwidth nature of the signals propagated through optical fiber 405.

However, in certain other embodiments, optical fiber 405 is a single-mode optical fiber, optical transmitter device 410 is a laser device and optical receiver device 415 is a high-speed, wide bandwidth device selected in accordance with a high-speed, wide-bandwidth nature of the signals propagated through optical fiber 405. It will be understood that optical fiber 405 is not limited to the coupling configuration (central office 105 to remote housing 320) as shown in FIG. 3, but may be used in various other embodiments to couple various entities other than CO 105 and remote housing 320.

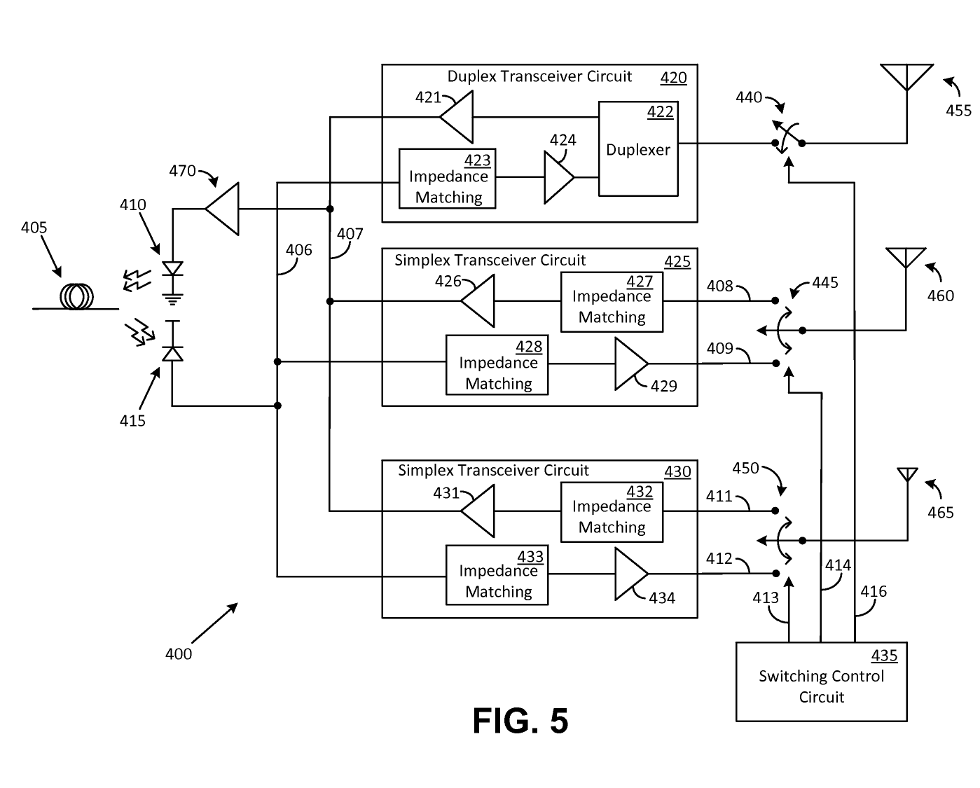

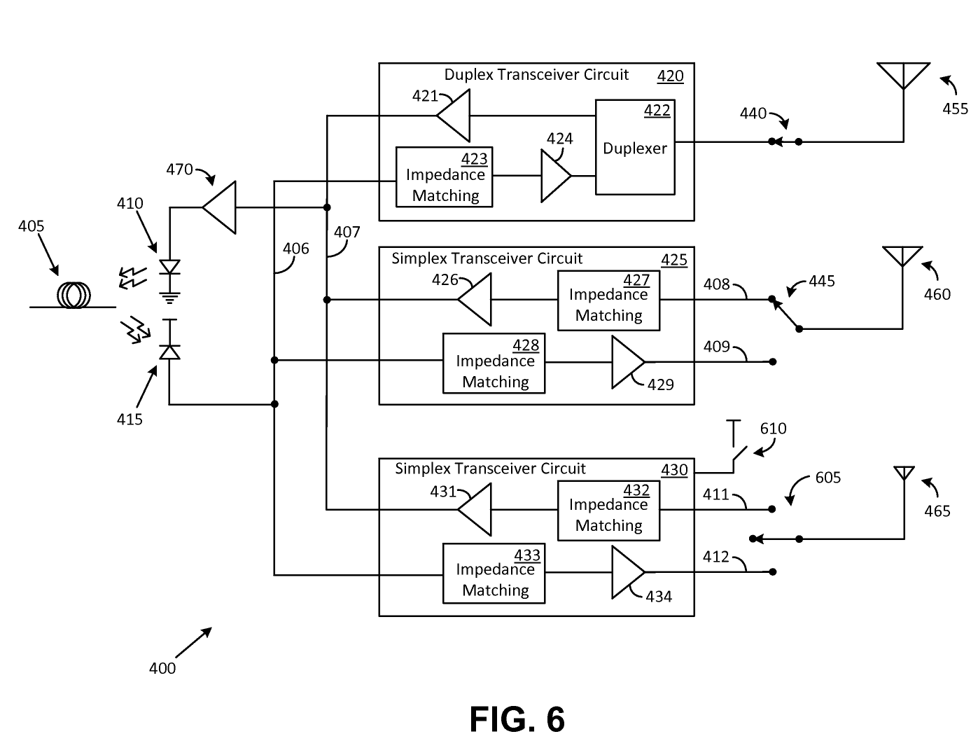

Optical receiver device 415 is coupled to receive side circuitry contained inside each of duplex transceiver circuit 420, simplex transceiver circuit 425, and simplex transceiver circuit 430. Additional details pertaining to these circuits will be provided below using FIGS. 5 and 6. Optical transmitter device 410 is coupled to transmit side circuitry contained inside each of duplex transceiver circuit 420, simplex transceiver circuit 425, and simplex transceiver circuit 430.

Duplex transceiver circuit 420 is coupled to a switch 440, which in turn is connected to a first antenna 455. Antenna 455 may be a microwave antenna (as shown by antenna 225 in FIG. 3) or may be any other suitable antenna selected on the basis of specific applications (for example, cellular telephony applications). Switch 440 is operative under control of switching control circuit 435, to couple or decouple antenna 455 to/from duplex transceiver circuit 420.

Switch 440 may be implemented in various ways. For example, in a first implementation, switch 440 is an electro-mechanical device such as a single pole single throw (SPST) relay. In another implementation, switch 440 is a solid state device such as a FET-based switching device.

Simplex transceiver circuit 425 is coupled to a switch 445, which in turn is connected to a second antenna 460. Antenna 455 may be an RF antenna (as shown by antenna 335 in FIG. 3) or may be any other suitable antenna selected on the basis of specific applications (for example, cellular telephony applications). Switch 445 is operative under control of switching control circuit 435, to couple antenna 460 to one of two alternative connections into simplex transceiver circuit 420. Specifically, switch 445 is operative to couple antenna 460 to either link 408 or to link 409.

Switch 445 may be implemented in various ways. For example, in a first implementation, switch 445 is an electro-mechanical device such as a single pole double throw (SPDT) relay. In another implementation, switch 445 is a solid state device such as a FET-based switching device.

Simplex transceiver circuit 430 is coupled to a switch 450, which in turn is connected to a third antenna 465. Switch 450 is operative under control of switching control circuit 435, to couple antenna 465 to one of two alternative connections into simplex transceiver circuit 430. Specifically, switch 450 is operative to couple antenna 465 to either link 411 or to link 412.

Switch 450 may be implemented in various ways. For example, in a first implementation, switch 450 is an electro-mechanical device such as a single pole double throw (SPDT) relay. In another implementation, switch 450 is a solid state device such as a FET-based switching device.

It will be understood that in other embodiments, in place of one duplex transceiver circuit and two simplex transceiver circuits, other combinations of such circuits may be used. For example, in one alternative embodiment, configurable transceiver 400 includes only one simplex transceiver circuit and one duplex transceiver circuit, while in another alternative embodiment, configurable transceiver 400 includes two duplex transceiver circuits and two simplex transceiver circuits. Furthermore, of these two duplex transceiver circuits and two simplex transceiver circuits, one duplex transceiver circuit and one simplex transceiver circuit may be used for redundancy purposes.

It will also be understood that the signals propagated through the various duplex and simplex transceiver circuits may occupy a wide variety of bandwidths and a wide variety of communication formats. Towards this end, antenna 455 is pictorially depicted by a larger symbol than antenna 460, which in turn is pictorially depicted by a larger symbol than antenna 465, for purposes of convenience to indicate that the range of frequencies and formats in the three antennae are diverse in nature.

In one exemplary embodiment, antenna 455 is selected to be effective for receiving/transmitting signals in a frequency division duplex (FDD) mode of operation. Referring back to FIG. 3, in the FDD mode of operation, a downstream signal originated from configurable transceiver 305 in central office 105 and propagated towards remote housing 320 uses one frequency, while an upstream signal originated from configurable transceiver 325 in remote housing 320 and propagated towards central office 105 uses a different frequency.

In contrast, antenna 460 is selected to be effective for receiving/transmitting signals in a time division duplex (TDD) mode of operation wherein different time slots are used to propagate different signals in each of the upstream and downstream direction. It should also be understood that in certain embodiments, configurable transceiver 400 may incorporate elements, such as wide band amplifiers and passive devices that are format agnostic, thereby interchangeably accommodating signals in any of multiple formats such as FDD and/or TDD.

In one specific exemplary embodiment, antenna 455 is selected to be effective for receiving/transmitting signals that confirm to cellular industry standards that are known to persons of ordinary skill in the art by 4G, LTE and WiMax terminology. In this specific exemplary embodiment, antenna 460 is selected to be effective for receiving/transmitting signals that confirm to cellular industry standards that are known to persons of ordinary skill in the art by 3G, WCDMA and DECT terminology. Furthermore, in this specific exemplary embodiment, antenna 465 is selected to be effective for receiving/transmitting signals that confirm to standards that are known to persons of ordinary skill in the art by 60 GHz, WiGig terminology.

As indicated above, though each of these standards are evolving and changing over time, the operative features of configurable transceiver 400 remain equally pertinent and valid for each of these variants. For example, the 4G, 3G and 60 GHz standards not only incorporate different data transfer rates as well as different signaling formats but also change over time. The corresponding antenna and transceiver circuits may be modified suitably to accommodate these changes.

Switching control circuit 435 provides control signals that are used to operate the various switches, via links 413, 414 and 416. In certain embodiments, these control signals maybe provided infrequently on as as-needed basis. For example, the control signals may be provided during an initial set-up procedure and not changed subsequently. One example of such a process is described below using FIG. 6.

In other embodiments, the control signals provided by switching control circuit 435 on one or both links 413 and 414, for example, may be referred to as real-time signals. For example, the control signal on line 414 may vary in accordance with a TDD format, thereby coupling antenna 460 to link 408 for a first period of time and then to link 409 for a different period of time. In other words, the control signal provided on link 414 places simplex transceiver circuit 425 in a transmit mode of operation whereby a signal is transmitted out of antenna 460 for a certain period of time, and then places simplex transceiver circuit 425 in a receive mode of operation whereby a signal is received from antenna 460 for another period of time, the two periods of time defined by a TDD operating mode.

Attention is now drawn to FIG. 5, which provides some details of a few elements located in duplex transceiver circuit 420 and the two simplex transceiver circuits 425 and 430.

Duplex transceiver circuit 420 includes duplexer 422 which accommodates bi-directional signal propagation by allowing antenna 455 to concurrently transmit a signal of a first frequency and to receive a signal of a different frequency (FDD mode of operation). The signal received from antenna 455 is coupled from duplexer 422 into a buffer/driver 421 which drives this signal (via another buffer 470) into optical transmitter device 410, which in turn drives this signal as a radio-over-fiber (RoF) signal into optical fiber 405.

In the opposite direction, an RoF signal received by optical receiver device 415 from optical fiber 405 is coupled into duplexer 422 via an impedance matching circuit 423 and a buffer/driver 424. Impedance matching circuit 423 is selected in accordance with the nature of optical receiver device 415 and the nature (bandwidth, wavelength, frequency etc) of the RoF signal received from optical fiber 405 and detected in optical receiver device 415.

Duplexer 422 may be implemented in a variety of ways based on the nature of the signals propagated through duplexer 422. For relatively lower frequency/bandwidth signals, duplexer 422 may be a coupling transformer and/or a pair of op-amps suitably interconnected to each other. On the other hand, for higher frequency/bandwidth signals, duplexer 422 may be a microwave device such as a circulator and/or a coupler.

FIG. 6 shows an exemplary configuration implemented on configurable transceiver 400. It should be noted that two elements that are not shown in previous figures have been included in FIG. 6.

Switch 605 is a 3-position switch that provides an alternative exemplary implementation whereby antenna 465 may be connected to one of links 411 or 412, or disconnected from both links. When disconnected from both links 411 and 412, simplex transceiver circuit 430 may be defined as being in a disabled/inactivated state. Switch 610 is also a part of an alternative exemplary implementation that permits power to be disconnected from simplex transceiver circuit 430, say for example, when simplex transceiver circuit 430 is in the disabled/inactivated state.

Similar switches and other switching arrangements may be made on simplex transceiver circuit 425, as well as on duplex transceiver circuit 420, when it is desired to place configurable transceiver 400 in a power conservation condition.

In the exemplary configured state shown in FIG. 6, switching control circuit 435 (not shown) is operated so as to provide suitable control signals that place switch 440 in a closed position, switch 445 in a position such that antenna 460 is coupled to link 408, and switch 605 in a position such that antenna 465 is decoupled from both of links 411 and 412. Configuring of all or some of the three switches may be carried out on a one-time basis, for example, during an initial set-up procedure of configurable transceiver 400.

With switch 440 in the closed position, duplex transceiver circuit 420 in conjunction with antenna 455 operates on various types of RoF signals that may be propagated through optical fiber 405. Such signals include FDD signals, frequency division multiple access (FDMA), and code division multiple access (CDMA) signals, that are typically bi-directional in nature.

In contrast, with switch 445 coupled to link 408, simplex transceiver circuit 425 in conjunction with antenna 460 operates on various types of RoF signals that are transmitted into optical fiber 405, but not signals that are transmitted from optical fiber 405 into simplex transceiver circuit 425.

In an alternative configuration, switch 445 is coupled to link 409, thereby allowing simplex transceiver circuit 425 to provide to antenna 460, various types of RoF signals that are received by simplex transceiver circuit 425 from optical fiber 405. In this alternative configuration, no signals are provided by simplex transceiver circuit 425 to optical fiber 405.

Simplex transceiver circuit 430 may not only be configured in the manner described above with reference to simplex transceiver circuit 425, but as a result of using a 3-position switch 605, may be also entirely disconnected from antenna 465.

It will be understood that though the description above (using FIGS. 4-6) has been directed at configurable transceiver 400 located in remote housing 320 (as shown in FIG. 3), configurable transceiver 305 located in central office 105 (as shown in FIG. 3) may be configured in a similar manner. In place of antennae 455, 460 and 465, the multiple signals that are to be propagated as RoF signals via optical fiber 310 (or 405), may be provided to configurable transceiver 305 via other suitable interfaces for example, from other telecommunication devices located in central office 105.

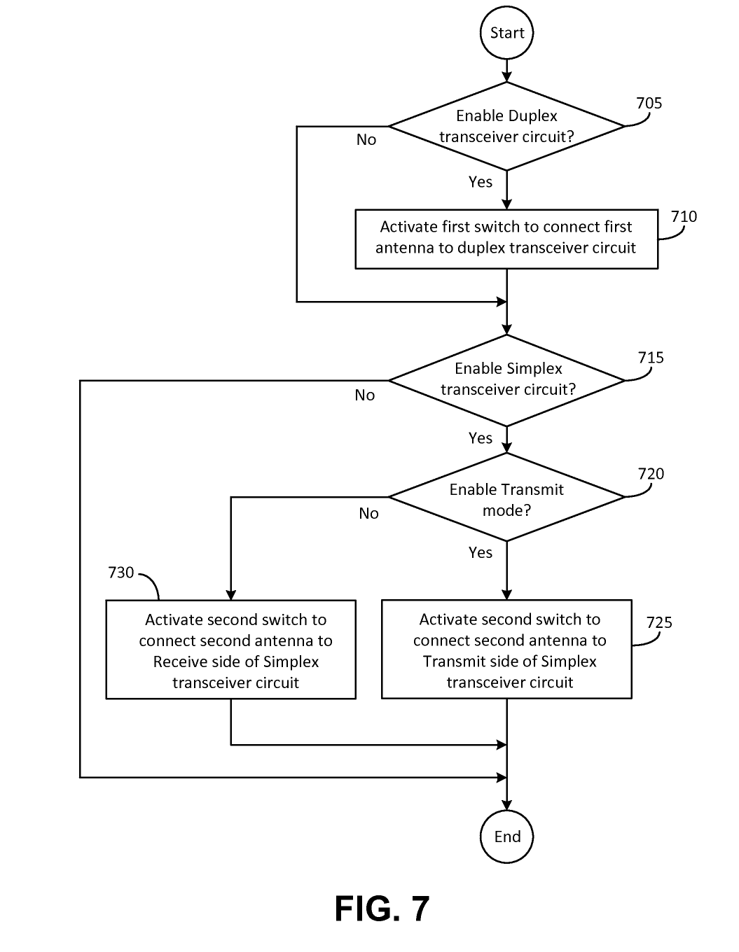

FIG. 7 shows a flowchart of a method of operating configurable transceiver 400. It is to be understood that any method steps or blocks shown in FIG. 7 may represent modules, segments, or portions of code that include one or more executable instructions for implementing specific logical functions or steps in the method. In certain implementations, one or more of the steps may be performed manually. It will be appreciated that, although particular example method steps are described below, additional steps or alternative steps may be utilized in various implementations without detracting from the spirit of the invention. Moreover, steps may be executed out of order from that shown or discussed, including substantially concurrently or in reverse order, depending on various alternative implementations. Code may be also contained in one or more devices, and may not be necessarily confined to any particular type of device. The explanation below, while possibly implying code residency and functionality in certain devices, does so solely for the purposes of explaining concepts behind the invention, and should not be construed in a limiting manner.

Furthermore, the description below makes reference to various elements described above using FIG. 5. However, this has been done merely for purpose of explanation and it should be understood that the flowchart is applicable to various configurations and is not limited solely to the exemplary embodiments described above. Also, the labels “transmit” and “receive” have been used below with reference to signal flow to/from antennas 455, 460 and 465 (rather than to/from optical fiber 405). Specifically, signals received by antennas 455, 460 and 465 and provided to the duplex/simplex transceiver circuits are referred to herein as receive-side signals, and signals provided to antennas 455, 460 and 465 by the duplex/simplex transceiver circuits are referred to herein as transmit-side signals, for purposes of convenience.

In block 705, a determination is made if duplex transceiver circuit 420 is to be enabled. If enablement is desired, in block 710, switch 440 (FIG. 5) is activated so as to connect antenna 455 to duplex transceiver circuit 420, followed by the action described in block 715. On the other hand, if it is determined in block 705 that duplex transceiver circuit 420 is not to be enabled, the operation shown in block 710 is omitted and action flows from block 705 to block 715 instead.

In block 715, a determination is made if simplex circuit 425 is to be enabled. If simplex circuit 425 is not to be enabled, flow chart operation is terminated. On the other hand, if enablement is desired, in block 720, another determination is made whether a transmit mode of operation is to be enabled.

If enablement is desired, in block 725, switch 445 (FIG. 5) is activated so as to connect antenna 460 to link 409 whereby the transmit side of simplex transceiver circuit 425 (impedance matching 428 and buffer 429) is connected to antenna 460.

If enablement of transmit mode is not desired in block 720, action flows to block 730, followed by termination of flowchart operations. In block 730, switch 445 (FIG. 5) is activated so as to connect antenna 460 to link 408 whereby the receive side of simplex transceiver circuit 425 (impedance matching 427 and buffer 426) is connected to antenna 460, followed by termination of flowchart operations.

It will be understood that though the flow chart indicates a termination of operations after blocks 730 and 725 are implemented, in various alternative embodiments, additional blocks may be implemented prior to termination. For example, such additional blocks may be directed at configuring a third simplex transceiver circuit 430 and/or a second duplex transceiver circuit, when such circuits are incorporated into configurable transceiver 400.

The person skilled in the art will appreciate that the description herein is directed at explaining merely a few aspects of a configurable multi-format, multi-band transceiver in accordance with the invention.

While the systems and methods have been described by means of specific embodiments and applications thereof, it is understood that numerous modifications and variations could be made thereto by those skilled in the art without departing from the spirit and scope of the disclosure.

Accordingly, it is to be understood that the inventive concept is not to be limited by the specific illustrated embodiments, but only by the scope of the appended claims. The description may provide examples of similar features as are recited in the claims, but it should not be assumed that such similar features are identical to those in the claims unless such identity is essential to comprehend the scope of the claim. In some instances the intended distinction between claim features and description features is underscored by using slightly different terminology.

What is claimed is:

1. A configurable transceiver comprising:
a duplex transceiver circuit, comprising:
a first antenna operative over a first radio frequency band;
a first transmitter configured to operate upon a first transmit signal having a first communication format; and
a first receiver configured to operate upon a first receive signal having the first communication format;
a first switch operable to selectively couple the first antenna to the duplex transceiver circuit when the communication transceiver is configured to enable a duplex mode of operation, and to selectively decouple the first antenna from the duplex transceiver circuit when the communication transceiver is configured for disabling the duplex mode of operation;
a first simplex transceiver circuit, comprising:
a second antenna operative over a second radio frequency band;
a second transmitter configured to operate upon a second transmit signal having a second communication format; and
a second receiver configured to operate upon a second receive signal having the second communication format; and
a second switch operable to selectively couple the second antenna to: a) the second transmitter, when the communication transceiver is configured to enable a transmit mode of operation in the second communication format, or b) the second receiver when the communication transceiver is selectively configured to enable a receive mode of operation in the second communication format.

2. The transceiver of claim 1, further comprising:
an optical fiber;
an optical receiver device configured to receive from the optical fiber, the first transmit signal, and to couple the first transmit signal into the first transmitter; and
an optical transmitter device configured to receive from the first receiver, the first receive signal, and to couple the first receive signal into the optical fiber.

3. The transceiver of claim 2, further comprising:
the optical receiver device configured to receive from the optical fiber, the second transmit signal, and to couple the second transmit signal into the second transmitter; and
the optical transmitter device configured to receive from the second receiver, the second receive signal, and to couple the second receive signal into the optical fiber.

4. The transceiver of claim 3, further comprising:
a second simplex transceiver circuit, comprising:
a third antenna operative over a third radio frequency band;
a third transmitter configured to operate upon a third transmit signal having a third communication format; and
a third receiver configured to operate upon a third receive signal having the third communication format; and
a third switch operable to selectively couple the third antenna to: a) the third transmitter, when the communication transceiver is configured to enable a transmit mode of operation in the third communication format, or b) the third receiver when the communication transceiver is selectively configured to enable a receive mode of operation in the third communication format.

5. The transceiver of claim 4, wherein the first communication format is a Frequency Division Duplex (FDD) format, and at least one of the second or third communication formats is a Time Division Duplex (TDD) format.

6. The transceiver of claim 5, further comprising:
the optical receiver device configured to receive from the optical fiber, the third transmit signal, and to couple the third transmit signal into the third transmitter; and
the optical transmitter device configured to receive from the third receiver, the third receive signal, and to couple the third receive signal into the optical fiber.

7. The transceiver of claim 5, wherein the first communication format is in accordance with the 4G cellular phone mobile communications standard, the second communication format is in accordance with the 3G cellular phone mobile communications standard, and the third communication format is in accordance with a 60 GHz Wireless Gigabit standard.

8. The transceiver of claim 5, wherein the 4G cellular phone mobile communications standard is at least one of the mobile WiMax standard or the Long Term Evolution (LTE) standard.

9. The transceiver of claim 5, wherein the optical fiber is a multimode optical fiber, the optical receiver device comprises a photo-detector diode, and the optical transmitter device comprises a light emitting diode.

10. The transceiver of claim 5, wherein the optical fiber is a single mode optical fiber, and the optical transmitter device comprises a laser diode.

11. The transceiver of claim 5, further comprising:
a switch control circuit for controlling the first, second and third switches.

12. A method of operating a configurable transceiver, the method comprising:
enabling a duplex mode of operation by activating a first switch to couple a first antenna to a duplex transceiver circuit, the duplex transceiver circuit comprising:
a first transmitter configured to operate upon a first transmit signal having a first communication format; and
a first receiver configured to operate upon a first receive signal having the first communication format; and
enabling a first simplex mode of operation by activating a second switch to couple a second antenna into one of a) a second transmitter that is configured to operate upon a second transmit signal having a second communication format or b) a second receiver that is configured to operate upon a second receive signal having the second communication format.

13. The method of claim 12, further comprising:
disabling the duplex mode of operation by activating the first switch to decouple the first antenna from the duplex transceiver circuit.

14. The method of claim 12, wherein enabling the first simplex mode of operation comprises providing a first control signal to the second switch, the first control signal characterized by a first Time Division Duplex (TDD) format.

15. The method of claim 12, further comprising:
enabling a second simplex mode of operation by activating a third switch to couple a third antenna into one of a) a third transmitter that is configured to operate upon a third transmit signal having a third communication format or b) a third receiver that is configured to operate upon a third receive signal having the third communication format.

16. The method of claim 15, wherein enabling the second simplex mode of operation comprises providing a second control signal to the third switch, the second control signal characterized by a second Time Division Duplex (TDD) format.

17. A configurable transceiver comprising:
a duplex transceiver circuit, comprising:
a first antenna operative over a first radio frequency band;
a first transmitter configured to operate upon a first transmit signal occupying at least a portion of the first radio frequency band; and
a first receiver configured to operate upon a first receive signal occupying the at least a portion of the first radio frequency band;
a first switch operable to selectively couple the first antenna to the duplex transceiver circuit when the communication transceiver is configured to enable a duplex mode of operation, and to selectively decouple the first antenna from the duplex transceiver circuit when the communication transceiver is configured for disabling the duplex mode of operation; and
a first simplex transceiver circuit, comprising:
a second antenna operative over a second radio frequency band;
a second transmitter configured to operate upon a second transmit signal occupying at least a portion of the second radio frequency band; and
a second receiver configured to operate upon a second receive signal occupying the at least a portion of the second radio frequency band; and
a second switch operable to selectively couple the second antenna to one of a) the second transmitter, or b) the second receiver.

18. The transceiver of claim 17, wherein the first transmit signal has a first communication format, the first receive signal has the first communication format, the second transmit signal has a second communication format, and the second receive signal has the second communication format.

19. The transceiver of claim 18, wherein the first communication format is a Frequency Division Duplex (FDD) format, and the second communication format is a Time Division Duplex (TDD) format.

20. The transceiver of claim 19, further comprising:
a second simplex transceiver circuit, comprising:
a third antenna operative over a third radio frequency band;
a third transmitter configured to operate upon a third transmit signal occupying at least a portion of the third radio frequency band; and
a third receiver configured to operate upon a third receive signal occupying the at least a portion of the third radio frequency band; and
a third switch operable to selectively couple the third antenna to one of a) the third transmitter, or b) the third receiver.
